(19) United States
(12) Patent Application Publication
(10) Pub. No.: US 2009/0021934 A1
(43) Pub. Date: Jan. 22, 2009

(54) OPTICAL ILLUMINATING SYSTEM

(76) Inventor: Michael Yi CHU, Taipei City (TW)

Correspondence Address: LADAS & PARRY LLP, 224 SOUTH MICHIGAN AVENUE, SUITE 1600, CHICAGO, IL, 60604, US

(21) Appl. No.: 11/934,830

(22) Filed: Nov. 5, 2007

(30) Foreign Application Priority Data
Jul. 17, 2007 (TW) 096126006

(51) Int. Cl. F21V 13/04; F21V 5/00; F21V 7/00

(52) U.S. Cl. 362/241; 362/237; 362/355

(57) ABSTRACT

An optical illuminating system is adapted to receive and scatter light from a primary light source, such as the sun. The optical illuminating system includes a light input device adapted for receiving the light from the primary light source, a light output device, and a light transmission device that is coupled optically to the light input device and the light output device for transmitting the light received by the light input device to the light output device by total reflection. The light output device scatters the light received from the light transmission device for output.

### CROSS-REFERENCE TO RELATED APPLICATION

This application claims priority of Taiwanese application no. 096126006, filed on Jul. 17, 2007.

### BACKGROUND OF THE INVENTION

1. Field of the Invention

The invention relates to an illuminating system, more particularly to an optical illuminating system capable of receiving and scattering light from a primary light source, such as the sun.

2. Description of the Related Art

In recent years, solar powered devices have been proposed to supply power to electrical illuminating systems. In practice, solar energy is converted into electrical energy using solar cells, and the electrical energy is subsequently converted into light energy when the electrical illuminating system is activated. While electric power consumption can be saved through such a scheme, conversion from solar energy into electrical energy and from electrical energy into light energy are inefficient. In particular, since efficiency of conversion from solar energy into electrical energy is only about 12%, and since efficiency of conversion from electrical energy into light energy is only about 25%, only 3% of solar energy is actually utilized for illumination.

There is thus a need to find ways to make more efficient use of solar energy.

### SUMMARY OF THE INVENTION

Therefore, the object of the present invention is to provide an optical illuminating system that is capable of using solar energy efficiently.

According to the present invention, there is provided an optical illuminating system adapted to receive and scatter light from a primary light source, such as the sun. The optical illuminating system comprises a light input device adapted for receiving the light from the primary light source, a light output device, and a light transmission device that is coupled optically to the light input device and the light output device for transmitting the light received by the light input device to the light output device by total reflection. The light output device scatters the light received from the light transmission device for output.

### BRIEF DESCRIPTION OF THE DRAWINGS

Other features and advantages of the present invention will become apparent in the following detailed description of the embodiments with reference to the accompanying drawings, of which:

FIG. 1 is a schematic diagram of the first embodiment of an optical illuminating system according to the present invention;

FIG. 2 is a schematic diagram of the second embodiment of an optical illuminating system according to the present invention;

FIG. 3 is a schematic diagram of the third embodiment of an optical illuminating system according to the present invention;

FIG. 4 is a schematic diagram of the fourth embodiment of an optical illuminating system according to the present invention;

FIG. 5 is a schematic diagram of a modified light output device suitable for the optical illuminating system of the present invention;

FIG. 6 is a schematic diagram of another modified light output device suitable for the optical illuminating system of the present invention; and

FIG. 7 is a fragmentary perspective view of a cleaning device suitable for the optical illuminating system of the present invention.

### DETAILED DESCRIPTION OF THE EMBODIMENTS

Before the present invention is described in greater detail with reference to the accompanying embodiments, it should be noted herein that like elements are denoted by the same reference numerals throughout the disclosure.

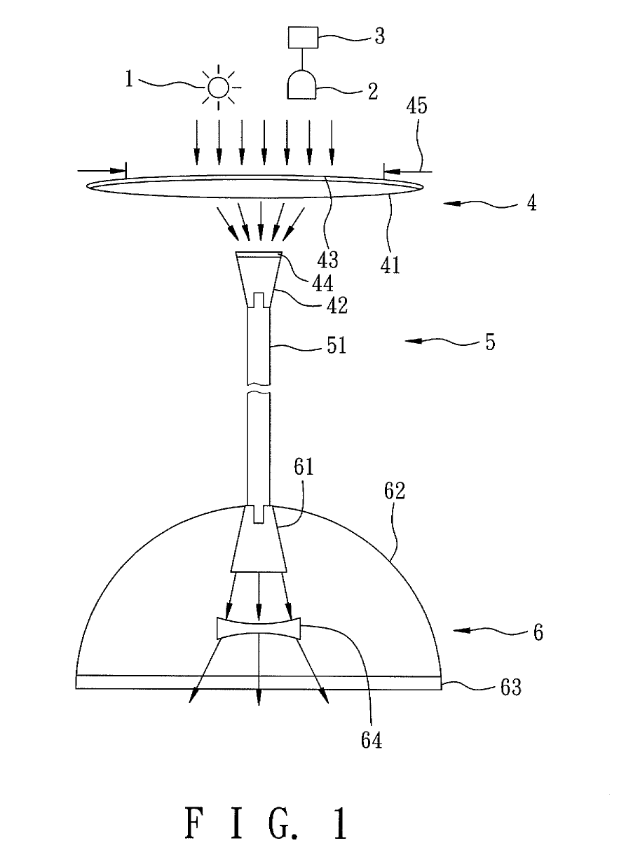

Referring to FIG. 1, the first embodiment of an optical illuminating system according to the present invention is shown to be adapted to receive and scatter light from a primary light source 1. The optical illuminating system comprises an auxiliary light source 2, a control device 3, a light input device 4, a light transmission device 5, and a light output device 6.

The primary light source 1 is the sun.

The auxiliary light source 2 is an artificial light source, such as a metal Halide discharge lamp.

The control device 3 is coupled to the auxiliary light source 2 for controlling intensity of illumination of the auxiliary light according to illumination of the light from the primary light source 1. Through control of the auxiliary light source 2 by the control device 3, adequate illumination can be ensured even when illumination from the primary light source 1 is insufficient.

The light input device 4 is configured to receive the light from the primary light source 1 and the auxiliary light from the auxiliary light source 2, and is movable to follow direction of the primary light source 1. In this embodiment, the light input device 4 includes: a condenser 41 for gathering the light from the primary light source 1 and the auxiliary light from the auxiliary light source 2; an input component 42 having a light incident side located proximate to a focal point of the condenser 41, and a light exit side coupled optically to the light transmission device 5; a reflective film 43 formed on the condenser 41 for reflecting infrared light and ultraviolet light; an anti-reflective film 44 formed on an end face of the light incident side of the input component 42 for preventing reflection of visible light; and a control unit 45 for controlling magnitude of light flux received by the condenser 41. In this embodiment, the light incident side of the input component 42 has a cross-sectional area larger than that of the light exit side. In addition, the light incident side of the input component 42 may have a flat or a concave end face. In this embodiment, the cross-sectional area of the light incident side of the input component 42 is slightly larger than a beam area of light received from the condenser 41. The control unit 45 can be halogen glass widely used in sunglasses or an adjustable iris mechanism used in cameras, and serves to block overabundant sunlight in summer, sunny days or noontime into a room that is installed with the optical illuminating system of this invention. In this embodiment, the area of the condenser 41 is designed according to average sunlight in an entire year. Thus, when there is overabundant sunlight in summer, sunny days or noontime, the control unit 45 is used to limit the magnitude of light flux received by the condenser 41. As a result, large differences in brightness in a room between summer and winter, sunny days and cloudy days, noontime and other time periods, etc., can be avoided.

The light transmission device 5 includes a light transmitting component 51 coupled optically to the input component 42 of the light input device 4 and the light output device 6 for transmitting the light received by the input component 42 of the light input device 4 to the light output device 6 by total reflection. The light propagating through the input component 42 enters the light transmitting component 51 at incident angles of less than 15 degrees.

The light output device 6 is used to scatter the light received from the light transmission device 5 for output, and includes: an output component 61 that has a light input side coupled optically to the light transmitting component 51 of the light transmission device 5 and that has a light output side; a hemispherical lampshade 62 having the output component 61 extending therein and having an open side; a transparent lens plate 63 for closing the open side of the hemispherical lampshade 62; and a scattering lens 64 located in the lampshade 62 between the light output side of the output component 61 and the transparent lens plate 63. In this embodiment, the output component 61 gradually diverges from the light input side to the light output side. The light output side of the output component 61 may have a flat or a concave end face.

In operation, the light from the primary light source 1 and the auxiliary light from the auxiliary light source 2 pass in sequence through the condenser 41 and the input component 42 and enter the light transmitting component 51 at incident angles of less than 15 degrees. The light transmitting component 51 transmits the light from the input component 42 to the output component 61 by total reflection. The light that exits the output component 61 is scattered by the scattering lens 64 and is subsequently outputted through the transparent lens plate 63.

In the first embodiment, the light from the primary light source 1 and the auxiliary light from the auxiliary light source 2 are directly received, transmitted and outputted through the light input device 4, the light transmission device 5 and the light output device 6. No energy conversion is involved, and light from the primary light source 1 and the auxiliary light source 2 are utilized directly. Since energy losses attributed to energy conversions in the prior art can be avoided, the energy utilization efficiency is significantly increased. Moreover, by using the sun as the primary light source 1, use of limited natural energy resources on the planet can be reduced. Furthermore, through the auxiliary light source 2 and the control device 3, adequate illumination can be ensured even when illumination from the primary light source 1 is insufficient (such as at night or during cloudy days).

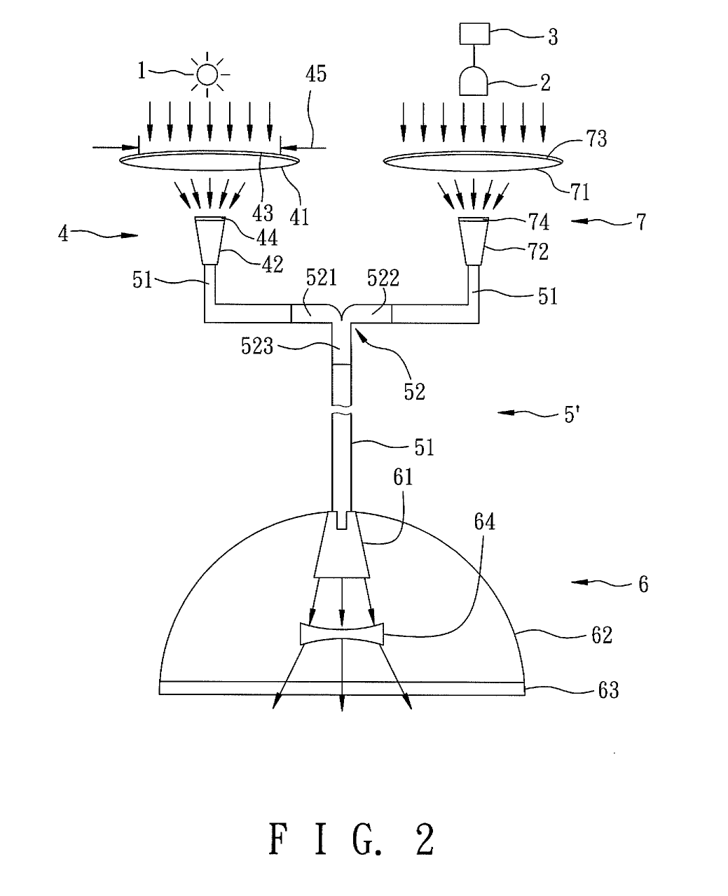

FIG. 2 illustrates the second embodiment of an optical illuminating system according to this invention, which is a modification of the previous embodiment. Unlike the first embodiment, the optical illuminating system of this embodiment includes an auxiliary light input device 7 and a modified light transmission device 5′

In this embodiment, the light input device 4 is for receiving the light from the primary light source 1, whereas the auxiliary light input device 7 is for receiving the auxiliary light from the auxiliary light source 2. The auxiliary light input device 7 is coupled optically to the light transmission device 5′. The light transmission device 5′ merges the light received by the light input device 4 with the auxiliary light received by the auxiliary light input device 7 for subsequent transmission to the light output device 6 by total reflection.

The auxiliary light input device 7 includes: an auxiliary condenser 71 for gathering the auxiliary light from the auxiliary light source 2; an auxiliary input component 72 that has a light incident side located proximate to a focal point of the auxiliary condenser 71 and that has a light exit side coupled optically to the light transmission device 5′; a reflective film 73 formed on the auxiliary condenser 71 for reflecting infrared light and ultraviolet light; and an anti-reflective film 74 formed on an end face of the light incident side of the auxiliary input component 72 for preventing reflection of visible light. In this embodiment, the light incident side of the auxiliary input component 72 has a cross-sectional area larger than that of the light exit side of the auxiliary input component 72. The auxiliary light propagating through the auxiliary input component 72 enters the light transmission device 5′ at incident angles of less than 15 degrees. The light incident side of the auxiliary input component 72 may have a flat or a concave end face. In this embodiment, the cross-sectional area of the light incident side of the auxiliary input component 72 is slightly larger than a beam area of light received from the auxiliary condenser 71.

The light transmission device 5′ includes a light merging component 52 and three light transmitting components 51. The light merging component 52 has a first branch portion 521 coupled optically to the input component 42 of the light input device 4 via a first one of the light transmitting components 51, a second branch portion 522 coupled optically to the auxiliary input component 72 of the auxiliary light input device 7 via a second one of the light transmitting components 51, and a merging portion 523 coupled optically to the first and second branch portions 521, 522. The merging portion 523 is coupled optically to the output component 61 of the light output device 6 via a third one of the light transmitting components 51, which transmits light merged by the merging portion 523 to the output component 61 of the light output device 6 by total reflection. In this embodiment, the first and second branch portions 521, 522 are merged into the merging portion 523 in a same direction and at an angle not larger than 10 degrees.

In operation, the light from the primary light source 1 passes in sequence through the condenser 41, the input component 42, the first one of the light transmitting components 51, and the first branch portion 521. On the other hand, the auxiliary light from the auxiliary light source 2 passes in sequence through the auxiliary condenser 71, the auxiliary input component 72, the second one of the light transmitting components 51, and the second branch portion 522. Thereafter, the light from the first branch portion 521 and the light from the second branch portion 522 are merged by the merging portion 523, and the third one of the light transmitting components 51 transmits the merged light to the output component 61 by total reflection. The light that exits the output component 61 is scattered by the scattering lens 64 and is subsequently outputted through the transparent lens plate 63.

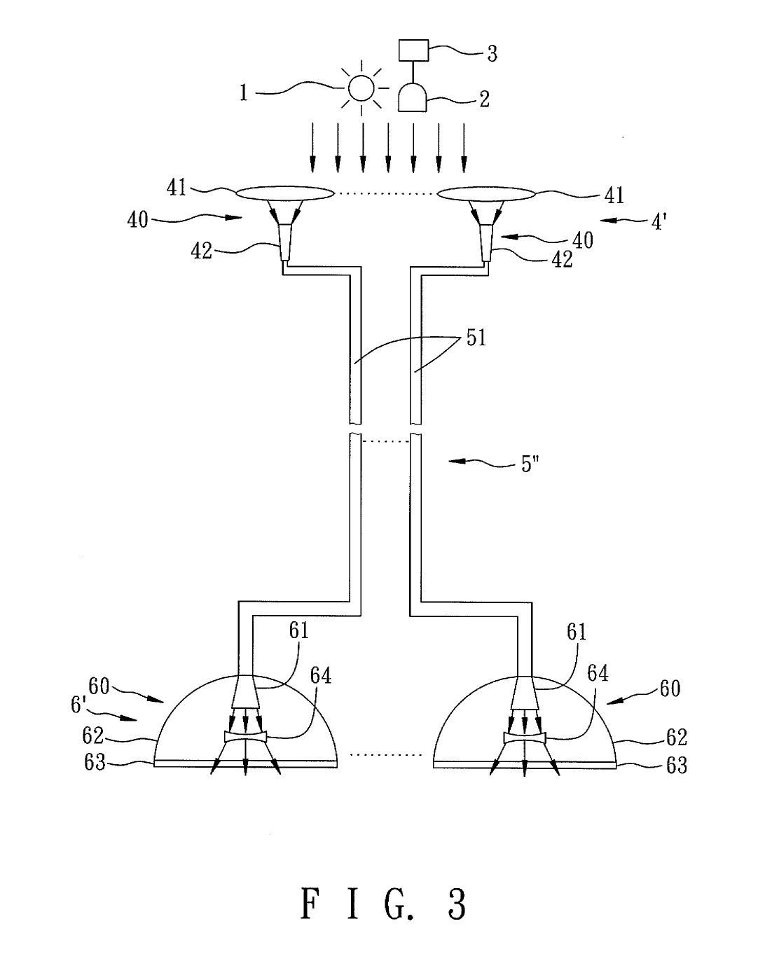

FIG. 3 illustrates the third embodiment of an optical illuminating system according to this invention, which is a modification of the first embodiment. Unlike the first embodiment, in the optical illuminating system of this embodiment, the light input device 4′ includes a plurality of light receiving units 40 each receiving the light from the primary light source 1 and the auxiliary light from the auxiliary light source 2, the light output device 6′ includes a plurality of output units 60, and the light transmission device 5″ includes a plurality of light transmitting components 51 each coupled optically to a respective one of the light receiving units 40 of the light input device 4′ and a respective one of the output units 60 of the light output device 6′.

Each of the light receiving units 40 includes a condenser 41, an input component 42, a reflective film 43, an anti-reflective film 44, and a control unit 45 (only the condenser 41 and the input component 42 are shown in FIG. 3 for the sake of clarity), which are the components of the light input device 4 of the first embodiment. Each of the output units 60 includes an output component 61, a hemispherical lampshade 62, a transparent lens plate 63, and a scattering lens 64, which are the components of the light output device 6 of the first embodiment. The opposite ends of each of the light transmitting components 51 are connected optically to the input component 42 of the respective light receiving unit 40 and the output component 61 of the respective output unit 60.

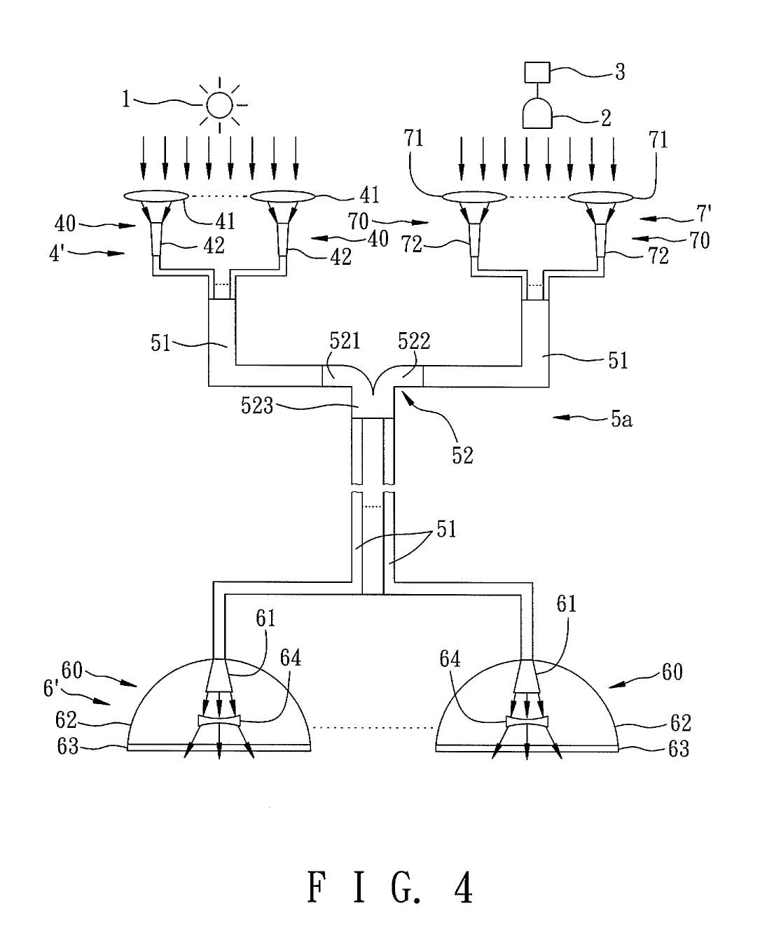

FIG. 4 illustrates the fourth embodiment of an optical illuminating system according to this invention, which is a modification of the second embodiment. Unlike the second embodiment, in the optical illuminating system of this embodiment, the light input device 4′ includes a plurality of light receiving units 40 each receiving the light from the primary light source 1, the auxiliary light input device 7′ includes a plurality of auxiliary light receiving units 70 each receiving the auxiliary light from the auxiliary light source 2, the light output device 6′ includes a plurality of output units 60, and the light transmission device (5a) includes a light merging component 52 and three light transmitting components 51. The light merging component 52 has a first branch portion 521 coupled optically to the light receiving units 40 of the light input device 4′ via a first one of the light transmitting components 51, a second branch portion 522 coupled optically to the auxiliary light receiving units 70 of the auxiliary light input device 7′ via a second one of the light transmitting components 51, and a merging portion 523 coupled optically to the first and second branch portions 521, 522. The merging portion 523 is coupled optically to the output units 60 of the light output device 6′ via a third one of the light transmitting components 51, which transmits light merged by the merging portion 523 to the output units 60 by total reflection.

Each of the light receiving units 40 includes a condenser 41, an input component 42, a reflective film 43, an anti-reflective film 44, and a control unit 45 (only the condenser 41 and the input component 42 are shown in FIG. 4 for the sake of clarity), which are the components of the light input device 4 of the first embodiment. Each of the auxiliary light receiving units 70 includes an auxiliary condenser 71, an auxiliary input component 72, a reflective film 73, and an anti-reflective film 74 (only the auxiliary condenser 71 and the auxiliary input component 72 are shown in FIG. 4 for the sake of clarity), which are the components of the auxiliary light input device 7 of the second embodiment. Each of the output units 60 includes an output component 61, a hemispherical lampshade 62, a transparent lens plate 63, and a scattering lens 64, which are the components of the light output device 6 of the first embodiment.

It should be noted that the primary light source 1 can be an artificial light source in other applications of the third and fourth embodiments of this invention. In such applications, the auxiliary light source 2 and the control device 3 are not required. High-power light generated by the artificial light source is similarly distributed among various output units of the light output device through the light input device and the light transmission device. Since a high-power light source consumes less energy when generating high-power light, for instance, a 1200 W metal Halide discharge lamp can emit 120000 lumens of light corresponding to the amount emitted by 100 100 W incandescent light bulbs, efficient energy utilization is still possible when the artificial light source is utilized as the primary light source 1.

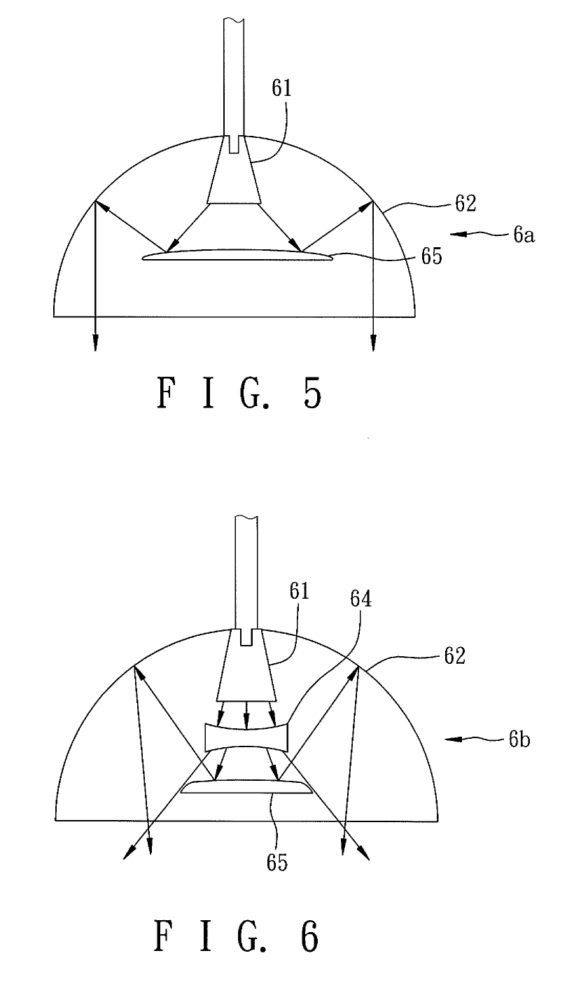

FIGS. 5 and 6 illustrate possible modifications of the light output device 6. In FIG. 5, the light output device (6a) includes an output component 61, a hemispherical lampshade 62 having the output component 61 extending therein, and a scattering reflector 65 located in the lampshade 62 for reflecting at least a portion of light from the output component 61 to the lampshade 62 so as to be further reflected by the lampshade 62 for output. The light output device (6b) in FIG. 6 is generally similar to that in FIG. 5, the difference residing in the inclusion of a scattering lens 64 between the output component 61 and the scattering reflector 65 so that a portion of light from the output component 61 is reflected by the scattering reflector 65 to the lampshade 62 so as to be further reflected by the lampshade 62, while the remaining portion of light from the output component 61 is scattered and outputted without being reflected by the scattering reflector 65. Since the above are only two of the many possible modifications of the light output device 6 evident to those skilled in the art, the design and implementation of the light output device 6 should not be limited to those disclosed herein.

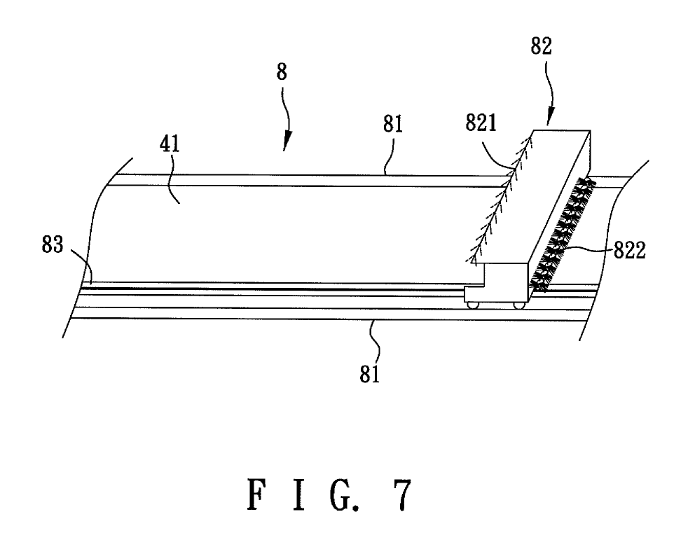

Referring to FIG. 7, the light input device of the optical illuminating system of the present invention can optionally include a reciprocating cleaning device 8 located adjacent to the condensers 41 (only one is shown in FIG. 7) for cleaning a light-receiving surface of the condensers 41. The cleaning device 8 includes a pair of rails 81 each located at a respective one of opposite lateral edges of the condensers 41, a cleaning assembly 82 capable of reciprocating movement on the rails 81, and a liquid discharging component 83 located at one of the lateral edges of the condensers 41. The cleaning assembly 82 includes a spray head 821 for spraying cleaning liquid, and a brush head 822 for brushing the light-receiving surface of the condensers 41. Due to the spraying action of the spray head 821 and the brushing action of the brush head 822 during reciprocating movement of the cleaning assembly 82 on the rails 81, the light-receiving surface of the condensers 41 can be kept clean so that the light extracting efficiency will not be degraded due to accumulation of dust and other contaminants. The dirty liquid is then collected through the liquid discharging component 83 for subsequent discharge.

In summary, through the optical illuminating system of this invention, light from the primary light source 1 is directly received, transmitted, and outputted through the light input device 4, the light transmission device 5 and the light output device 6. No energy conversion is involved, and energy losses attributed to energy conversions in the prior art can be avoided, thereby increasing the energy utilization efficiency significantly. Moreover, by using the sun as the primary light source 1, use of limited natural energy resources on the planet can be reduced. The purpose of this invention is accordingly served.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An optical illuminating system adapted to receive and scatter light from a primary light source, said optical illuminating system comprising:
a light input device adapted for receiving the light from the primary light source;
a light output device; and
a light transmission device coupled optically to said light input device and said light output device for transmitting the light received by said light input device to said light output device by total reflection, said light output device scattering the light received from said light transmission device for output.

2. The optical illuminating system as claimed in claim 1, further comprising an auxiliary light source for generating auxiliary light, said light input device being configured to receive the light from the primary light source and the auxiliary light from said auxiliary light source for subsequent transmission to said light output device via said light transmission device.

3. The optical illuminating system as claimed in claim 2, further comprising a control device coupled to said auxiliary light source for controlling intensity of illumination of the auxiliary light according to illumination of the light from the primary light source.

4. The optical illuminating system as claimed in claim 1, wherein said light input device includes
a condenser for gathering the light from the primary light source, and
an input component having a light incident side located proximate to a focal point of said condenser, and a light exit side coupled optically to said light transmission device, said light incident side having a cross-sectional area larger than that of said light exit side; and
wherein the light propagating through said input component enters said light transmission device at incident angles of less than 15 degrees.

5. The optical illuminating system as claimed in claim 4, wherein said light incident side of said input component has a concave end face.

6. The optical illuminating system as claimed in claim 4, wherein said light input device further includes a control unit for controlling magnitude of light flux received by said condenser.

7. The optical illuminating system as claimed in claim 4, wherein said light input device further includes a reflective film formed on said condenser for reflecting infrared light and ultraviolet light.

8. The optical illuminating system as claimed in claim 4, wherein said light input device further includes an anti-reflective film formed on an end face of said light incident side of said input component for preventing reflection of visible light.

9. The optical illuminating system as claimed in claim 1, wherein said light output device includes an output component having a light input side coupled optically to said light transmission device, and a light output side, said output component gradually diverging from said light input side to said light output side.

10. The optical illuminating system as claimed in claim 9, wherein said light output side of said output component has a concave end face.

11. The optical illuminating system as claimed in claim 9, wherein said light output device further includes:
a hemispherical lampshade having said output component extending therein and having an open side;
a transparent lens plate for closing said open side of said hemispherical lampshade; and
a scattering lens located in said lampshade between said light output side of said output component and said transparent lens plate.

12. The optical illuminating system as claimed in claim 1, wherein the primary light source is the sun.

13. The optical illuminating system as claimed in claim 12, wherein said light input device is movable to follow direction of the primary light source.

14. The optical illuminating system as claimed in claim 1, further comprising an auxiliary light source for generating auxiliary light, and an auxiliary light input device for receiving the auxiliary light from said auxiliary light source, said auxiliary light input device being coupled optically to said light transmission device to permit transmission of the auxiliary light received by said auxiliary light input device to said light output device by total reflection.

15. The optical illuminating system as claimed in claim 14, further comprising a control device coupled to said auxiliary light source for controlling intensity of illumination of the auxiliary light according to illumination of the light from the primary light source.

16. The optical illuminating system as claimed in claim 14, wherein said auxiliary light input device includes
an auxiliary condenser for gathering the auxiliary light from said auxiliary light source, and
an auxiliary input component having a light incident side located proximate to a focal point of said auxiliary condenser, and a light exit side coupled optically to said light transmission device, said light incident side having a cross-sectional area larger than that of said light exit side; and
wherein the auxiliary light propagating through said auxiliary input component enters said light transmission device at incident angles of less than 15 degrees.

17. The optical illuminating system as claimed in claim 16, wherein said light incident side of said auxiliary input component has a concave end face.

18. The optical illuminating system as claimed in claim 16, wherein said auxiliary light input device further includes a reflective film formed on said auxiliary condenser for reflecting infrared light and ultraviolet light.

19. The optical illuminating system as claimed in claim 16, wherein said auxiliary light input device further includes an anti-reflective film formed on an end face of said light incident side of said auxiliary input component for preventing reflection of visible light.

20. The optical illuminating system as claimed in claim 14, wherein said light transmission device includes a light merging component and three light transmitting components,
said light merging component having a first branch portion coupled optically to said light input device via a first one of said light transmitting components, a second branch portion coupled optically to said auxiliary light input device via a second one of said light transmitting components, and a merging portion coupled optically to said first and second branch portions,
said merging portion being coupled optically to said light output device via a third one of said light transmitting components, which transmits light merged by said merging portion to said light output device by total reflection.

21. The optical illuminating system as claimed in claim 1, wherein said light input device includes a plurality of light receiving units each receiving the light from the primary light source, said light output device includes a plurality of output components, and said light transmission device includes a plurality of light transmitting components each coupled optically to a respective one of said light receiving units of said light input device and a respective one of said output components of said light output device.

22. The optical illuminating system as claimed in claim 1, further comprising an auxiliary light source for generating auxiliary light, and an auxiliary light input device,
said light input device including a plurality of light receiving units each receiving the light from the primary light source,
said auxiliary light input device including a plurality of auxiliary light receiving units each receiving the auxiliary light from said auxiliary light source,
said light output device including a plurality of output components,
said light transmission device including a light merging component and three light transmitting components,
said light merging component having a first branch portion coupled optically to said light receiving units of said light input device via a first one of said light transmitting components, a second branch portion coupled optically to said auxiliary light receiving units of said auxiliary light input device via a second one of said light transmitting components, and a merging portion coupled optically to said first and second branch portions,
said merging portion being coupled optically to said output components of said light output device via a third one of said light transmitting components, which transmits light merged by said merging portion to said output components by total reflection.

23. The optical illuminating system as claimed in claim 9, wherein said light output device further includes a hemispherical lampshade having said output component extending therein, and a scattering reflector located in said lampshade for reflecting at least a portion of light from said output component to said lampshade so as to be further reflected by said lampshade.

24. The optical illuminating system as claimed in claim 23, wherein said light output device further includes a scattering lens located between said output component and said scattering reflector.

25. The optical illuminating system as claimed in claim 1, wherein said light input device includes a plurality of condensers for gathering the light from the primary light source, and a reciprocating cleaning device located adjacent to said condensers for cleaning a light-receiving surface of said condensers.
